(19) United States
(12) Patent Application Publication
(10) Pub. No.: US 2021/0278954 A1
(43) Pub. Date: Sep. 9, 2021

(54) PROJECTING INPUTS TO THREE-DIMENSIONAL OBJECT REPRESENTATIONS

(71) Applicant: HEWLETT-PACKARD DEVELOPMENT COMPANY, L.P., Spring, TX (US)

(72) Inventor: Nathan Barr NUBER, Fort Collins, CO (US)

(73) Assignee: Hewlett-Packard Development Company, L.P., Spring, TX (US)

(21) Appl. No.: 16/482,303

(22) PCT Filed: Jul. 18, 2017
(86) PCT No.: PCT/US2017/042565

§ 371 Date: Jul. 31, 2019

(51) Int. Cl. G06F 3/0481; G06F 3/01; G02B 27/01; G06T 7/70; G06T 19/00

(52) U.S. Cl. CPC G06F 3/04815; G06F 3/011; G02B 2027/0138; G06T 7/70; G06T 19/006; G02B 27/017

(57) ABSTRACT

In some examples, a system causes display of a representation of an input surface, and causes display of a representation of a three-dimensional (3D) object. In response to an input made by an input device on the input surface, the system projects the input to the representation of the 3D object based on an angle of the input device relative to a reference, and interacts with the representation of the 3D object at an intersection of the projected input and the representation of the 3D object.

### BACKGROUMND

A simulated reality system can be used to present simulated reality content on a display device. In some examples, simulated reality content includes virtual reality content that includes virtual objects that a user can interact with using an input device. In further examples, simulated reality content includes augmented reality content, which includes images of real objects (as captured by an image capture device such as a camera) and supplemental content that is associated with the images of the real objects. In additional examples, simulated reality content includes mixed reality content (also referred to as hybrid reality content), which includes images that merge real objects and virtual objects that can interact

### BRIEF DESCRIPTION OF THE DRAWINGS

Some implementations of the present disclosure are described with respect to the following figures.

FIG. 1 is a block diagram of an arrangement that includes an input surface and an input device according to some examples.

FIGS. 2 and 3 are cross-section views showing projections of inputs made by an input device on an input surface to a representation of a three-dimensional (3D) object, according to some examples.

FIG. 4 is a flow diagram of a process to handle an input made by an input device, according to some examples.

FIG. 5 is a block diagram of a system according to further examples.

FIG. 6 is a block diagram of a storage medium storing machine-readable instructions, according to additional examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Simulated reality content can be displayed on display devices of any of multiple different types of electronic devices. In some examples, simulated reality content can be displayed on a display device of a head-mounted device. A head-mounted device refers to any electronic device (that includes a display device) that can be worn on a head of a user, and which covers an eye or the eyes of the user. In some examples, a head-mounted device can include a strap that goes around the user's head so that the display device can be provided in front of the user's eye. In further examples, a head-mounted device can be in the form of electronic eyeglasses that can be worn in the similar fashion as normal eyeglasses, except that the electronic eyeglasses include a display screen (or multiple display screens) in front of the user's eye(s). In other examples, a head-mounted device can include a mounting structure to receive a mobile device. In such latter examples, the display device of the mobile device can be used to display content, and the electronic circuitry of the mobile device can be used to perform processing tasks.

When wearing a head-mounted device to view simulated reality content, a user can hold an input device that can be manipulated by the user to make inputs on objects that are part of the simulated reality content. In some examples, the input device can include a digital pen, which can include a stylus or any other input device that can be held in a user's hand. The digital pen is touched to an input surface to make corresponding inputs.

Traditional input techniques using digital pens may not work robustly when a user is interacting with a three-dimensional (3D) object in a simulated reality content. Normally, when a digital pen is touched to an input surface, the point of contact is the point where interaction occurs with a displayed object. In other words, inputs made by the digital pen on the input surface occurs in a two-dimensional (2D) space, where just the X and Y coordinates in the 2D space of the point of contact between the digital pen and the input surface is considered in detecting where the input is made. User experience may suffer when using a 2D input technique such as described above to interact with 3D objects depicted in 3D space.

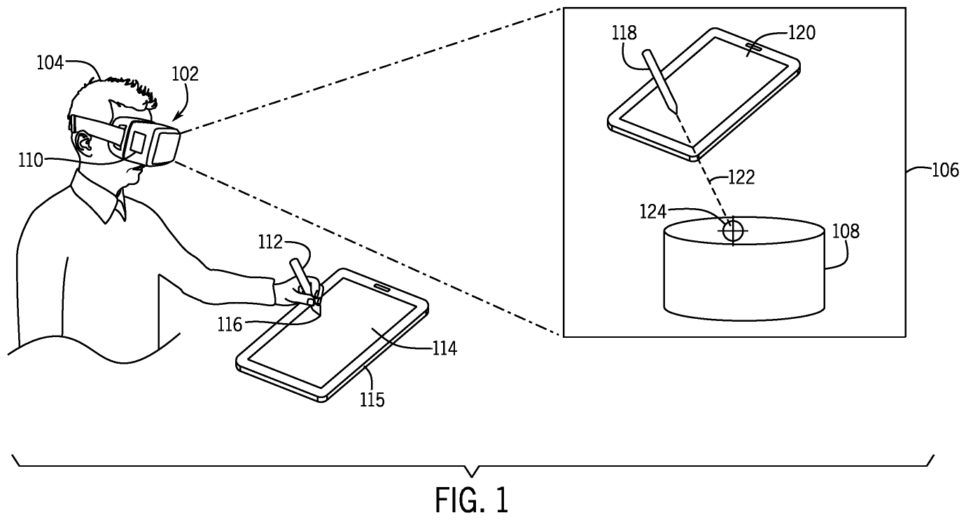

In accordance with some implementations of the present disclosure, as shown in FIG. 1, a system includes a head-mounted device 102 or any other type of electronic device that can include a display device 106 to display 3D objects. In other examples, other types of electronic devices can include display devices to display representations of objects. The head-mounted device 102 is worn on a user's head 104 during use.

The display device 106 can display a representation 108 of a 3D object (hereinafter “3D object representation” 108). The 3D object representation can be a virtual representation of the 3D object. A virtual representation of an object can refer to a representation that is a simulation of a real object, as generated by a computer or other machine, regardless of whether that real object exists or is structurally capable of existing. In other examples, the 3D object representation 108 can be an image of the 3D object, where the image can be captured by a camera 110, which can be part of the head-mounted device 102 (or alternatively can be part of a device separate from the head-mounted device 102). The camera 110 can capture an image of a real subject object (an object that exists in the real world), and produce an image of the subject object in the display 106.

Although just one camera 110 is depicted in FIG. 1, it is noted that in other examples, the system can include multiple cameras, whether part of the head-mounted device 102 or part of multiple devices.

The 3D object representation 108 that is displayed in the display device 106 is the subject object that is to be manipulated (modified, selected, etc.) using 3D input techniques or mechanisms according to some implementations of the present disclosure.

As further shown in FIG. 1, the user holds a real input device 112 in a hand of the user. The input device 112 can include an electronic input device or a passive input device.

An example of an electronic input device is a digital pen. A digital pen includes electronic circuitry that is used to facilitate the detection of inputs made by the digital pen with respect to a real input surface 114. The digital pen when in use is held by a user's hand, which moves the digital pen over or across the input surface 114 to make desired inputs. In some examples, the digital pen can include an active element (e.g., a sensor, a signal emitter such as a light emitter, an electrical signal, an electromagnetic signal emitter, etc.) that cooperates with the input surface 114 to cause an input to be made at a specific location where the input device 112 is brought into a specified proximity of the input surface 114. The specified proximity can refer to actual physical contact between a tip 116 of the input device 112, or alternatively, can refer to a proximity where the tip 116 is less than a specified distance from the input surface 114.

Alternatively or additionally, the digital pen 112 can also include a communication interface to allow the digital pen 112 to communicate with an electronic device, such as the head-mounted device 102 or another electronic device. The digital pen can communicate wirelessly or over a wired link.

In other examples, the input device 112 can be a passive input device that can be held by the user's hand while making an input on the input surface 114. In such examples, the input surface 114 is able to detect a touch input or a specified proximity of the tip 116 of the input device 112.

The input surface 114 can be an electronic input surface or a passive input surface. The input surface 114 includes a planar surface (or even a non-planar surface) that is defined by a housing structure 115. An electronic input surface can include a touch-sensitive surface. For example, the touch-sensitive surface can include a touchscreen that is part of an electronic device such as a tablet computer, a smartphone, a notebook computer, and so forth. Alternatively, a touch-sensitive surface can be part of a touchpad, such as the touchpad of a notebook computer, the touchpad of a touch mat, or other touchpad device.

In further examples, the input surface 114 can be a passive surface, such as a piece of paper, the surface of a desk, and so forth. In such examples, the input device 112 can be an electronic input device that can be used to make inputs on the passive input surface 114.

The camera 110, which can be part of the head-mounted device 102 or part of another device, can be used to capture an image of the input device 112 and the input surface 114, or to sense positions of the input device 112 and the input surface 114. In other examples, a tracking device different from the camera 110 can be used to track positions of the input device 112 and the input surface 114, such as gyroscopes in each of the input device 112 and the input surface 114, a camera in the input device 112, etc.

Based on the information of the input device 112 and the input surface 114 captured by the camera 110 (which can include one camera or multiple cameras and/or other types of tracking devices), the display device 106 can display a representation 118 of the input device 112, and a representation 120 of the input surface 114. The input device representation 118 can be an image of the input device 112 as captured by the camera 110. Alternatively, the input device representation 118 can be a virtual representation of the input device 112, where the virtual representation is a simulated representation of the input device 112 rather than a captured image of the input device 112.

The input surface representation 120 can be an image of the input surface 114, or alternatively, can be a virtual representation of the input surface 114.

As the user moves the input device 112 relative to the input surface 114, such movement is detected by the camera 110 or another tracking device, and the head-mo unted device 102 (or another electronic device) moves the displayed input device representation 118 by an amount relative to the input surface representation 120 corresponding to the movement of the input device 112 relative to the input surface 114.

In some examples, the displayed input surface representation 120 is transparent, whether fully transparent with visible boundaries to indicate the general position of the input surface representation 120, or partially transparent. The 3D object representation 108 displayed in the display device 108 is visible behind the transparent input surface representation 120.

By moving the input device representation 118 relative to the input surface representation 120 when the user moves the real input device 112 relative to the real input surface 114, the user is given feedback regarding relative movement of the real input device 112 to the real input surface 114, even though the user is wearing the head-mounted device 102 and thus cannot actually see the real input device 112 and the real input surface 114.

In response to an input made by the input device 112 on the input surface 114, the head-mounted device 102 (or another electronic device) projects (along dashed line 122 that presents a projection axis) the input to an intersection point 124 on the 3D object representation 108. The projection of the input along the projection axis 122 is based on an angle of the input device 112 relative to the input surface 114. The projected input interacts with the 3D object representation 108 at the intersection point 124 of the projected input and the 3D object representation 108.

The orientation of the displayed input device representation 118 relative to the displayed input surface representation 120 corresponds to the orientation of the real input device 112 to the real input surface 114. Thus, for example, if the real input device 112 is at an angle α relative to the real input surface 114, then the displayed input device representation 118 will be at the angle a relative to the displayed input surface representation 120. This angle a defines the projection axis 122 of projection of the input, which is made on a first side of the input surface representation 120, to the intersection point 124 of the 3D object representation 108 that is located on a second side of the input surface representation 120, where the second side is opposite of the first side.

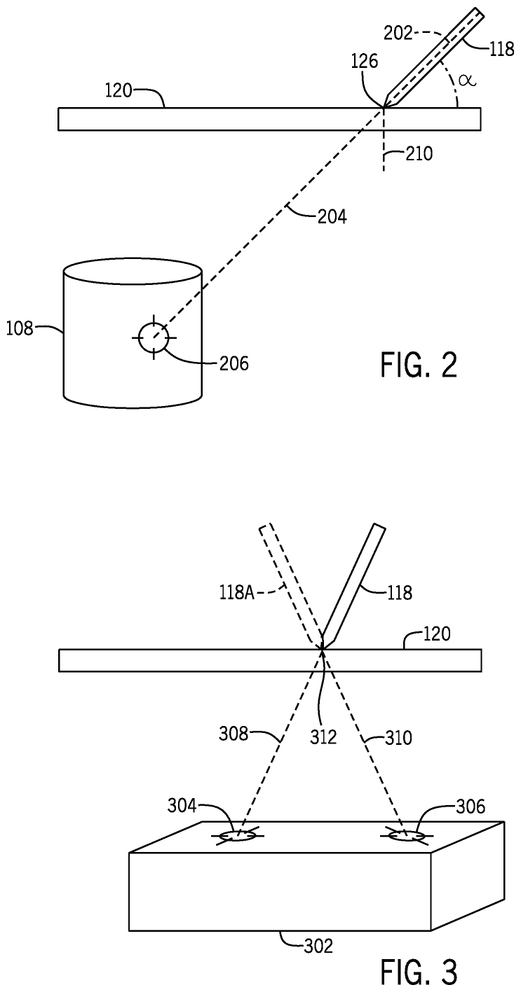

FIG. 2 is a cross-sectional side view of the input surface representation 120 and the input device representation 118. As depicted in FIG. 2, the input device representation 118 has a longitudinal axis 202 that extends along the length of the input device representation 118. The input device representation 118 is angled with respect to the input surface representation 120, such that the longitudinal axis 202 of the input device representation 118 is at an angle a relative to the front plane of the input surface representation 120.

The angle α can range in value between a first angle that is larger than 0° to a second angle that is less than 180°. For example, the input device representation 118 can have an acute angle relative to the input surface representation 120, where the acute angle can be 30°, 45°, 60° or any angle between 0° and 90°. Alternatively, the input device representation 118 can have an obtuse angle relative to the input surface representation 120, where the obtuse angle can be 120°, 135°, 140°, or any angle greater than 90° and less than 180°.

The input device representation 118 has a forward vector that generally extends along the longitudinal axis 202 of the input device representation 118. This forward vector is projected through the input surface representation 120 onto the 3D object representation 108 along a projection axis 204. The projection axis 204 extends from the forward vector of the input device representation 118.

The 3D projection of the input corresponding to the interaction between a tip 126 of the input device representation 118 with the front plane of the input surface representation 120 is along the projection axis 204 through a virtual 3D space (and through the input surface representation 120) to an intersection point 206 on the 3D object representation 108 that is on an opposite side of the input surface representation 120 than the input device representation 118. The projection axis 204 is at the angle α relative to the front plane of the input surface representation 120.

The projected input interacts with the 3D object representation 108 at the intersection point 206 of the projected input along the projection axis 204. For example, the interaction can include painting the 3D object representation 108, such as painting a color onto the 3D object representation 108 or providing a texture on the 3D object representation 108, at the intersection point 206. In other examples, the interaction can include sculpting the 3D object representation 108 to change the shape of the 3D object. As further examples, the projected input can be used to add an element to the 3D object representation 108, or remove (e.g., such as by cutting) an element from the 3D object representation 108.

In some examples, the 3D object representation 108 can be the subject of a computer aided design (CAD) application, which is used to produce an object having selected attributes. In other examples, the 3D object representation 108 can be part of a virtual reality presentation, an augmented reality presentation, an electronic game that includes virtual and augmented reality elements, and so forth.

In some examples, the 3D object representation 108 can remain fixed in space relative to the input surface representation 120, so as the input device representation 118 traverses the front plane of the input surface representation 120 (due to movement of the real input device 112 by the user), the input device representation 118 can point to different points of the 3D object representation 108. The ability to detect different angles of the input device representation 118 relative to the front plane of the input surface representation 120 allows the input device representation 118 to become a 3D input mechanism that can point to different spots of the 3D object representation 108.

In examples where the 3D object representation 108 remains fixed in space relative to the input surface representation 120, the 3D object representation 108 would move with the input surface representation 120. Alternatively, the 3D object representation 108 can remain stationary, and the input surface representation 120 can be moved relative to the 3D object representation 108.

FIG. 2 also shows another projection axis 210, which would correspond to a 2D input made with the input device representation 118. With a 2D input, the point of interaction (having an X, Y coordinate, for example) between the tip 126 of the input device representation 118 and the front plane of the input surface representation 120 would be the point where an input is made with respect to the 3D object representation 108. The projection axis 210 projects vertically downwardly below the point of interaction. Thus, in the example of FIG. 2, since no part of the 3D object representation 108 is underneath the point of interaction, the 2D input that is made along the projection axis 210 would not select any part of the 3D object representation 108. Generally, a 2D input made with the input device representation 118 does not consider the angle of the input device representation 118 relative to the input surface representation 120. Thus, with a 2D input, regardless of the angle of the input device representation 118 relative to the input surface representation 120, the input at the point of interaction would be projected vertically downwardly along the projection axis 210.

FIG. 3 shows an example where an input device representation is held at two different angles relative to the input surface representation 120. In FIG. 3, the input device representation 118 has a first angle relative to the input surface representation 120, which causes the corresponding input to be projected along a first projection axis 308 to a first intersection point 304 on a 3D object representation 302. In FIG. 3, the same input device representation (118A) at a second angle (different from the first angle) relative to the input surface representation 120 causes the corresponding input to be projected along a second projection axis 310 to a second intersection point 306 on the 3D object representation 302. Note that the input device representation at the two different angles (118 and 118A) makes an input at the same point of interaction 312 relative to the input surface representation 120.

The foregoing examples refer to projecting an input based on the angle a of the input device representation 118 relative to the displayed input surface representation 120. In other examples, such as when a 3D object representation (e.g., 108 in FIG. 2 or 302 in FIG. 3) is not fixed relative to the input surface representation 120, then the projecting can be based on an angle of the input device representation 118 relative to a different reference (e.g., a reference plane). The reference is fixed relative to the 3D object representation. Thus, generally, the reference can be the front plane of the input surface representation 120 in some examples, or a different reference in other examples.

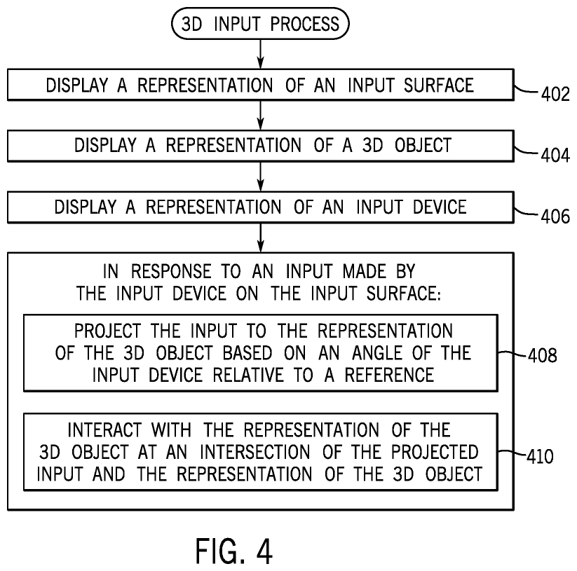

FIG. 4 is a flow diagram of a 3D input process according to some implementations of the present disclosure. The 3D input process can be performed by the head-mounted device 102, or by a system that is separate from the head-mounted device 102 and in communication with the head-mounted device 102.

The 3D input process includes displaying (at 402) a representation of an input surface in a display device (e.g., 106 in FIG. 1). For example, a position and orientation of the input surface in the real world can be captured by a camera (e.g., 110 in FIG. 1) or another tracking device, and the displayed representation of the input surface can have a position and orientation that corresponds to the position and orientation of the input surface in the real world.

The 3D input process also displays (at 404) a representation of a 3D object in the display device. The 3D input process also displays (at 406) a representation of an input device that is manipulated by a user. For example, a position and orientation of the input device in the real world can be captured by a camera (e.g., 110 in FIG. 1) or another tracking device, and the displayed representation of the input device can have a position and orientation that corresponds to the position and orientation of the input device in the real world.

In response to an input made by the input device on the input surface (e.g., a touch input made by the input device on the input surface or the input device being brought into a specified proximity to the input surface), the 3D input process projects (at 408) the input to the representation of the 3D object based on an angle of the input device relative to a reference, and interacts (at 410) with the representation of the 3D object at an intersection of the projected input and the representation of the 3D object. The interaction with the representation of the 3D object in response to the projected input can include modifying a part of the representation of the 3D object or selecting a part of the representation of the 3D object.

The orientation of each of the input surface and the input device can be determined in 3D space. For example, the yaw, pitch, and roll of each of the input surface and the input device are determined, such as based on information of the input surface and the input device captured by a camera (e.g., 110 in FIG. 1). The orientation (e.g., yaw, pitch, and roll) of each of the input surface and the input device is used to determine: (1) the actual angle of input device relative to the input surface (at the point of interaction between the input device and the input surface), and (2) the direction of the projection axis. Alternatively, the orientation of the input device can be used to determine the angle of the input device relative to a reference, and the direction of the projection axis.

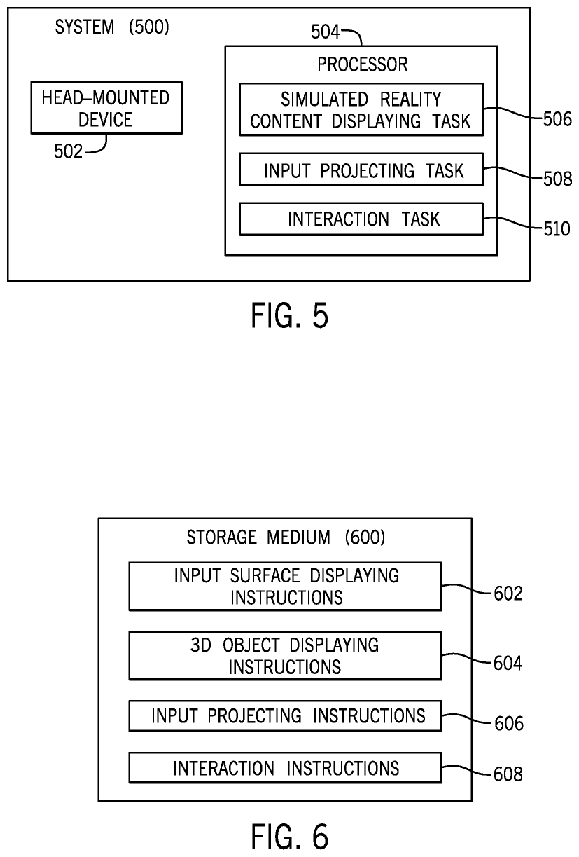

FIG. 5 is a block diagram of a system 500 that includes a head-mounted device 502 and a processor 504. The processor 504 can be part of the head-mounted device 502, or can be separate from the head-mounted device 502. A processor can include a microprocessor, a core of a multi-core microprocessor, a microcontroller, a programmable integrated circuit, a programmable gate array, or another hardware processing circuit. The processor 504 performing a task can refer to one processor performing the task, or multiple processors performing the task.

FIG. 5 shows the processor 504 performing various tasks, which can be performed by the processor 504, such as under control of machine-readable instructions (e.g., software or firmware) executed on the processor 504. The tasks include a simulated reality content displaying task 506 that causes display, by the head-mounted device 502, of a simulated reality content that includes a representation of an input surface and a representation of a 3D object. The tasks further include task 508 and task 510 that are performed in response to an input made by an input device on the input surface. The task 508 is an input projecting task that projects the input to the representation of the 3D object based on an angle of the input device relative to a reference. The task 510 is an interaction task that interacts with the representation of the 3D object at an intersection of the projected input and the representation of the 3D object.

FIG. 6 is a block diagram of a non-transitory machine-readable or computer-readable storage medium 600 storing machine-readable instructions that upon execution cause a system to perform various tasks.

The machine-readable instructions include input surface displaying instructions 602 to cause display of a representation of an input surface. The machine-readable instructions further include 3D object displaying instructions 604 to cause display of a representation of a 3D object. The machine-readable instructions further include instructions 606 and 608 that are executed in response to an input made by an input device on the input surface. The instructions 606 include input projecting instructions to project the input to the representation of the 3D object based on an angle of the input device relative to a reference. The instructions 608 include interaction instructions to interact with the representation of the 3D object at an intersection of the projected input and the representation of the 3D object.

The storage medium 600 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
cause display of a representation of an input surface;
cause display of a representation of a three-dimensional (3D) object; and
in response to an input made by an input device on the input surface:
project the input to the representation of the 3D object based on an angle of the input device relative to a reference, and
interact with the representation of the 3D object at an intersection of the projected input and the representation of the 3D object.

2. The non-transitory machine-readable storage medium of claim 1, wherein causing the display of the representation of the input surface comprises causing the display of the representation of a touch-sensitive surface, and wherein the input made by the input device comprises a touch input on the touch-sensitive surface.

3. The non-transitory machine-readable storage medium of claim 1, wherein the reference comprises a plane of the representation of the input surface.

4. The non-transitory machine-readable storage medium of claim 1, wherein causing the display of the representation of the input surface and the representation of the 3D object is on a display device of a head-mounted device.

5. The non-transitory machine-readable storage medium of claim 4, wherein the representation of the input surface comprises a virtual representation that corresponds to the input surface that is part of a real device.

6. The non-transitory machine-readable storage medium of claim 4, wherein the representation of the input surface comprises an image of the input surface captured by a camera.

7. The non-transitory machine-readable storage medium of claim 1, wherein the instructions upon execution cause the system to further:
cause display of a representation of the input device; and
move the representation of the input device in response to user movement of the input device.

8. The non-transitory machine-readable storage medium of claim 7, wherein the projecting comprises projecting along a projection axis that extends along a longitudinal axis of the representation of the input device and through the representation of the input surface to intersect with the representation of the 3D object.

9. The non-transitory machine-readable storage medium of claim 1, wherein the instructions upon execution cause the system to further:
determine an orientation of the input surface and an orientation of the input device, wherein the projecting is based on the determined orientation of the input surface and the determined orientation of the input device.

10. The non-transitory machine-readable storage medium of claim 1, wherein:
in response to a first angle of the input device relative to the reference when the input is made at a first location on the input surface, the input is projected to a first point on the representation of the 3D object, and in response to a second, different angle of the input device relative to the reference when the input is made at the first location on the input surface, the input is projected to a second, different point on the representation of the 3D object.

11. A system comprising:
a head-mounted device; and
a processor to:
cause display, by the head-mounted device, of a simulated reality content that includes a representation of an input surface and a representation of a three-dimensional (3D) object; and
in response to an input made by an input device on the input surface:
project the input to the representation of the 3D object based on an angle of the input device relative to a reference, and
interact with the representation of the 3D object at an intersection of the projected input and the representation of the 3D object.

12. The system of claim 11, wherein the projecting is along a projection axis that extends, in a virtual 3D space, along a longitudinal axis of the input device through the representation of the input surface to the representation of the 3D object.

13. The system of claim 11, wherein the processor is part of the head-mounted device or is part of another device separate from the head-mounted device.

14. A method comprising:
displaying a representation of an input surface;
displaying a representation of a three-dimensional (3D) object;
displaying a representation of an input device that is manipulated by a user; and
in response to an input made by the input device on the input surface:
projecting the input to the representation of the 3D object based on an angle of the input device relative to a reference, and
interacting with the representation of the 3D object at an intersection of the projected input and the representation of the 3D object.

15. The method of claim 14, wherein the representation of the input surface, the representation of the 3D object, and the representation of the input device are part of a simulated reality content displayed on a display device of a head-mounted device.
